(19) United States
(12) Patent Application Publication
(10) Pub. No.: US 2006/0093448 A1
(43) Pub. Date: May 4, 2006

(54) Drills

(76) Inventor: Alan Robert Kelsey, Sheffield (GB)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/255,315

(22) Filed: Oct. 21, 2005

(30) Foreign Application Priority Data
Oct. 28, 2004 (GB) 0423942.2

(51) Int. Cl. B23B 51/00

(52) U.S. Cl. 408/224

(57) ABSTRACT

A drill for thick plate material of over 10 mm depth. Drills for cutting thin plate material by way of hand held electric drills are known, but for drilling thick plate material, there has hitherto been used hollow drills that necessitate the use of central ejectors to remove a slug of metal cut from a plate, with added costs and complexity. This is avoided by providing a construction which includes a solid body formed with a central cutting tip at one end, behind which and extending towards the rear end of the drill is a first land of a required diameter and of a length of at least 11 mm, followed by at least one other land of required greater diameter and of a length of at least 11 mm, with a cutting shoulder connecting one land and a succeeding land, the body at the opposite end to the cutting tip, being provided with a connector whereby the drill can be secured to the chuck of a bench mounted drill or a portable drilling machine.

### RELATED/PRIORITY APPLICATION

This application claims the benefit of British application Serial No. 0423942.2, filed Oct. 28, 2004.

### FIELD OF INVENTION

This invention relates to drills, and is particularly but not necessarily exclusively concerned with drills for cutting holes in plate material.

### BACKGROUND OF THE INVENTION

Drills for cutting holes in thin plate material, for example, up to a thickness of 10 mm and known, and hitherto have predominantly been for use with hand held electric drills and not suited to heavier duty bench mounted or portable machine drills. With heavier plate material upwards of 11 mm thick, cutting of holes has been by way of fluted hollow drills or twist drill suitable for use with machine tools or portable drilling machines. With fluted hollow drills it is ordinarily so that they are provided with a central ejector to allow the removal of a slug of metal cut from the plate that penetrates in to the drill interior, at added cost and complexity.

In an attempt to allow a single drill to cut holes of different diameters, it is known to provide fluted hollow drills with a stepped outer surface, to provide a number of lengths of drill of progressively greater diameter, to allow the cutting of a first hole of one diameter, and then to widen the hole to a larger diameter dependent on how deep the drill is caused to penetrate through the plate. Here again, a central ejector is needed with those problems mentioned above.

### SUMMARY OF THE INVENTION

The object of the present invention is to provide a drill able to cut holes of different diameters in thick plate material.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a side elevation view of a drill.

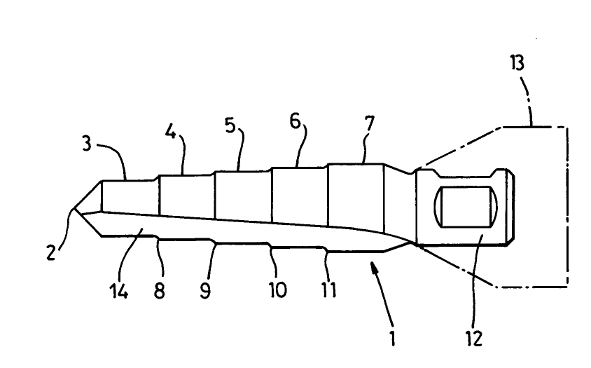

### DESCRIPTION

According to the present invention, a drill comprises a solid body formed with a central cutting tip at one end, behind which and extending towards the rear end of the drill is a first land of a required diameter and of a length of at least 11 mm, followed by at least one other land of required greater diameter and of a length of at least 11 mm, with a cutting shoulder connecting one land and a succeeding land, the body at the opposite end to the cutting tip, being provided with a connector whereby the drill can be secured to the chuck of a bench mounted drill or a portable drilling machine.

With a solid drill of the invention mounted in a drilling machine, it can be applied to plate material with considerable force, and the centre cutting tip caused to penetrate the plate material surface. However, a considerable advantage of the invention is that the centre cutting tip can engage with a pilot hole or punch mark in the plate material surface, an ability not to be found in hollow fluted drills.

Thus, a first hole of a required diameter can be cut in plate material of at least 11 mm thick, and the drill of the invention can be used to cut holes of up to 25 mm diameter and more, by urging the drill through the plate to bring lands of greater diameter into contact with a hole cut by a preceding land of a smaller diameter.

The drill of the invention can be used not only to cut a first hole in a thick plate without the need to provide for the ejection of a slug of metal, it can also be used to widen an existing hole to a greater diameter, and can correct, by opening out, the misalignment of holes in adjoining section of material, and also deburr the upper side of the drilled hole.

One embodiment of the invention will now be described with reference to the accompanying drawing, which is a side elevation of a drill.

In the drawing, a drill 1 has a solid body formed at one end with a central cutting tip 2 behind which and extending towards the rear end of the drill is a first land 3 of a required diameter and of a length of at least 11 mm, followed by successive land 4, 5, 6 and 7 all of progressively greater required diameters, and all of a length of at least 11 mm. Each land 3 to 6 is connected to each respective succeeding land 4 to 7 by respective cutting shoulders 8 to 11. At the opposite end of the drill 1 to the cutting tip 2, is a connector 12 to enable the drill to be secured in the chuck 13 of a bench mounted drill or a portable drilling machine.

The strength of the drill of the invention, and the power of the bench mounted or portable drilling machine are such that the drill 1 can be applied to plate material with considerable force, to cause the centre cutting tip 2 to penetrate the plate surface, with the advantage that a pilot hole or punch mark can first be created, and in which the top 2 of the drill can locate, to ensure that the drill does not perform a lateral movement, with the substantial guarantee that a hole is drilled where required.

Along the length of the drill, at least one flute 14 is provided, to cause the cutting action of the drill and the removal of swarf.

Once a first hole is drilled in plate material of 10 mm and more by the cutting tip 2, of the diameter of the first land 3, the diameter of that hole can be increased by urging the cutting shoulder 8 into contact with the top edge of the hole, to bring the diameter of the hole out to the diameter of the second land 4, and so on until the final shoulder 11 brings the hole diameter out to the diameter of the final land 7. In this manner, holes of, e.g. 25 mm diameter can be drilled in plate material of 10 mm and more, with relative ease and certainty of location.

The drill of the invention can also be used to widen the diameter of an existing hole in thick plate material, and equally can correct any misalignment between co-operating holes in adjacent plates by opening out one or both holes, and can be used to deburr the exposed edges of existing drilled holes.

What is claimed is:

1. A drill (1) comprising a solid body formed with a central cutting tip (2) at one end, behind which and extending towards the rear end of the drill is a first land (3) of a required diameter and of a length of at least 11 mm, followed by at least one other land (4 to 7) of required greater diameter and of a length of at least 11 mm, with a cutting shoulder (8 to 11) connecting one land (3 to 6) and a succeeding land (4 to 7), the body at the opposite end to the cutting tip (2), being provided with a connector (12) whereby the drill (1) can be secured to the chuck (13) of a bench mounted drill or a portable drilling machine.

2. A drill as in claim 1, wherein at least one flute (14) is provided along the length of the drill.

3. A drill as substantially hereinbefore described with reference to the accompanying drawing.
